(19) United States
(12) Patent Application Publication
(10) Pub. No.: US 2008/0001577 A1
(43) Pub. Date: Jan. 3, 2008

(54) Thin-film battery recharging systems and methods

(75) Inventor: Jeffrey S. Sather, Otsego, MN (US)

Correspondence Address: KAGAN BINDER, PLLC, SUITE 200, MAPLE ISLAND BUILDING, 221 MAIN STREET NORTH, STILLWATER, MN, 55082, US

(73) Assignee: Cymbet Corporation

(21) Appl. No.: 11/824,708

(22) Filed: Jul. 2, 2007

Related U.S. Application Data
(60) Provisional application No. 60/806,458, filed on Jun. 30, 2006.

(51) Int. Cl. H02J 7/04

(52) U.S. Cl. 320/162

(57) ABSTRACT

The present invention provides recharging systems and methods for solid state thin-film batteries. Recharging systems and methods in accordance with the present invention include circuits that receive energy that can be used for recharging from sources such as solar cells, magnetic induction, thermoelectric devices, and piezoelectric materials.

### CROSS-REFERENCE TO RELATED APPLICATION

The present application claims priority to U.S. Provisional Application No. 60/806,458, filed Jun. 30, 2006, the entire contents of which are incorporated herein by reference for all purposes.

### TECHNICAL FIELD

The present invention relates to thin-film batteries. More particularly, the present invention relates to recharging systems and methods for solid state thin-film batteries.

### BACKGROUND

Rechargeable batteries are generally known and used in a variety of commercial, automotive, industrial and consumer applications where the use of compact, light weight, high capacity and extended charge life portable power sources are desirable. For certain applications, such as computers, electronic devices, and electric vehicles, both size and weight are critical factors in selection of a suitable battery material.

Current battery technology comprises essentially two general classes of batteries, liquid electrolyte batteries and solid electrolyte batteries. Polymer electrolyte batteries are generally considered as hybrid class of liquid electrolyte batteries. Liquid electrolyte battery technology is well known in the art. Typical commercial examples of these battery types are lead-acid, nickel cadmium, and nickel metal hydride cells and commercial lithium batteries.

In liquid electrolyte batteries, the electrolyte provides for ion transport between the cathode and anode. Typically, the amount of energy stored and retrievable from a conventional electrolyte battery is directly proportional to battery size and weight. For example, a Pb-acid automotive battery is capable of producing large amounts of current but such batteries typically have relatively low energy density and specific energy due their large volume and weight. Additionally, the corrosive liquid electrolytes employed by these batteries require complex packaging and sealing which add dead weight and dead volume. Since liquid electrolytes are employed in these batteries, their operating temperatures are generally limited by the freezing point and boiling point of the liquid electrolyte and they are unsuitable for applications in severe environments such as desert or artic climates, deep sea, high altitude or space applications.

More recently, advances in anode, cathode, and electrolyte materials and materials fabrication methods have led to the development of polymer electrolyte batteries and solid-state electrolyte batteries. While polymer electrolyte batteries offer improvements over conventional liquid electrolyte batteries due to weight and size reductions which result in reduction of dead weight and volume, these batteries generally exhibit similar corrosion problems as liquid electrolyte batteries where the corrosive electrolytes which are employed react with anodes and cathodes and lead to rapid degradation of battery charging performance, reversible charge capacity and charge cycle lifetime.

Solid state batteries have a number of preferred advantages over liquid electrolyte batteries and polymer electrolyte batteries. Since no corrosive electrolyte materials are employed, corrosion problems are eliminated and simplified packaging and sealing of battery cells is possible, eliminating unnecessary dead weight and volume. Due to the elimination of corrosion problems by employing solid-state electrolytes, electrolyte reactions with anodes and cathodes are eliminated resulting in stable charge capacities, high reversible charge capacity after extended cycling, and long battery lifetimes. Thus, solid-state batteries are theoretically capable of much higher energy densities and specific energies than liquid or polymer electrolyte batteries. In addition, solid-state batteries are capable of operating in temperature ranges, which extend beyond either the freezing point or boiling point of a liquid electrolyte. For this reason, solid-state electrolyte batteries are particularly useful in severe environment applications in space, high altitudes, deep sea, desert or arctic climates.

Unlike commercial bulk batteries, which have relatively forgiving tolerances, the relatively slow solid-state ion diffusion kinetics and transport dimension constraints placed on electrolyte, anode and cathode film thickness and spacing in thin film, solid-state batteries impose demanding tolerances in the quality, structure, orientation and properties of as-deposited thin film electrolyte, anode and cathode layers. Since solid-state ion diffusion and transport through solid electrolytes is typically slower than diffusion in liquid electrolytes, minimizing the thickness of the thin film electrolyte and the resultant spacing between anode and cathode is controlled for desired solid-state battery performance. Typically, the thickness of thin film electrolytes and spacing between electrodes in these batteries range from one to two microns in order to minimize ion diffusion distances and provide adequate transport kinetics for acceptable current densities. In contrast, typical electrolyte, anode and cathode dimensions and electrode spacing in commercial liquid and polymer electrolyte batteries generally range from hundreds of microns to tens of centimeters.

Electronic devices are widespread and include some type of power supply or energy source with the device. Such devices include, for example, flashlights, cordless drills and other electric-powered mechanical tools, laptop computers, media players, pagers, personal data assistant devices, radios, automobiles, hearing aids, pacemakers, implantable drug pumps, identification tags for warehouse tracking and retail theft prevention, smart cards used for financial transactions, global positioning satellite location-determining devices, remote controllers for televisions and stereo systems, motion detectors and other sensors such as for security systems, and many other devices. Many portable devices use batteries as power supplies. Other power supplies, such as supercapacitors, and energy conversion devices, such as photovoltaic cells and fuel cells, are alternatives to batteries for use as power supplies in portable electronics and non-portable electrical applications. Such energy sources must have sufficient capacity to power the device so the device can operate as desired. Sufficient battery capacity can result in a power supply that is large compared to the rest of the device. Accordingly, smaller and lighter batteries with sufficient energy storage for use as power supplies are desired. Moreover, the ability to recharge such batteries allows further size reduction as the overall battery capacity for a particular device may be lessened if the battery can be regularly recharged.

Solid-state, thin-film batteries are often used for energy sources for electronic devices. Examples of thin-film batteries are described in U.S. Pat. Nos. 5,314,765; 5,338,625; 5,445,126; 5,445,906; 5,512,147; 5,561,004; 5,567,210; 5,569,520; 5,597,660; 5,612,152; 5,654,084; and 5,705,293, each of which is fully incorporated by reference herein for all purposes. U.S. Pat. No. 5,338,625 describes a thin-film battery, particularly a thin-film microbattery, and a method for making the same having application as a backup or first integrated power source for electronic devices and is fully incorporated by reference herein for all purposes. Also, U.S. Pat. No. 5,445,906 describes a method and system for manufacturing thin-film battery structures, which is fully incorporated by reference herein for all purposes. US Patent Application Publication No. 2004/0185310 describes combined battery and device apparatus and associated method for integrated battery-capacitor devices, which is fully incorporated by reference herein for all purposes. A particularly useful review of current solid-state, thin film battery technology is disclosed in Julian, et al., Solid State Batteries: Materials Design and Optimization, Kluwer Academic Publishers (Boston, Mass., 1994) which is fully incorporated by reference herein for all purposes.

### SUMMARY

The present invention provides recharging systems and methods for solid state thin-film batteries. Solid state thin-film batteries are more robust than conventional lithium-ion and lithium polymer cells with respect to recharge methods. Recharging systems and methods in accordance with the present invention comprise circuits that receive energy that can be used for recharging from sources such as solar cells, magnetic induction, thermoelectric devices, and piezoelectric materials, for example. Any suitable energy source can be used. Such circuits in accordance with the present invention are viable for use with solid state thin-film batteries because the battery can be charged efficiently using a potentiostatic charging regimen, without need for constant current sources, safety circuits, charge counters, or timers. Moreover, because the energy capacity of such batteries is relatively small compared with conventional Li-ion batteries, only a few microwatts to a few milliwatts of power is necessary to provide the charging current for charging the thin film battery in a short period of time, typically a few minutes. Further, the charging device is advantageously amenable to direct integration with a battery in accordance with the present invention, but is not essential that it be so.

In an aspect of the present invention a battery charging system is provided. The battery charging system comprises a solid state thin-film battery and a potentiostatic charging device comprising a voltage regulator. The potentiostatic charging device is capable of maintaining a first electrode of the solid state thin-film battery at a controlled potential with respect to a second electrode of the solid state thin-film battery during a charging period of the solid state thin-film battery. The solid state thin-film battery preferably comprises LiPON. The potentiostatic charging device preferably comprises one or more of a primary coil magnetically coupled to a secondary coil, a solar cell, a piezoelectric transducer, and a thermoelectric cell.

In another aspect of the present invention a method of charging a solid state thin-film battery is provided. The method comprising the steps of providing a battery charging system comprising a solid state thin-film battery and a potentiostatic charging device comprising a voltage regulator, providing an energy source, and using energy from the energy source to maintain a first electrode of the solid state thin-film battery at a controlled potential with respect to a second electrode of the solid state thin-film battery during a charging period. The solid state thin-film battery preferably comprises LiPON. The energy source preferably comprises one or more of a primary coil magnetically coupled to a secondary coil, a solar cell, a piezoelectric transducer, and a thermoelectric cell.

In another aspect of the present invention a tire pressure monitoring system is provided. The system comprises a tire pressure sensor, a signal transmitter capable of transmitting a signal from the tire pressure sensor to a receiver, and a power source comprising a solid state thin-film battery and a potentiostatic charging device comprising a piezoelectric transducer. The solid state thin-film battery preferably comprises LiPON.

In another aspect of the present invention a method of monitoring tire pressure is provided. The method comprises the steps of measuring the pressure of a tire with a pressure sensor, powering the pressure sensor with a solid state thin-film battery, and charging the solid state thin-film battery with energy provided by a piezoelectric transducer.

### BRIEF DESCRIPTION OF THE DRAWINGS

The accompanying drawings, which are incorporated in and constitute a part of this application, illustrate several aspects of the invention and together with description of the embodiments serve to explain the principles of the invention. A brief description of the drawings is as follows:

FIG. 1 is a schematic view of a solid state thin-film battery that can be used in a recharging system in accordance with the present invention;

FIG. 2 is a flow chart of an exemplary method for making the thin-film battery of FIG. 1;

FIG. 3 is a schematic view of a solid state thin-film battery recharging system that uses a potentiostatic charging device comprises a primary coil magnetically coupled to a secondary coil in accordance with the present invention;

FIG. 4 is a schematic view of an integrated RFID tag that comprises a recharging system in accordance with the present invention;

FIG. 5 is a schematic view of another solid state thin-film battery recharging system that uses a potentiostatic charging device comprises a primary coil magnetically coupled to a secondary coil in accordance with the present invention;

FIG. 6 is a schematic view of another solid state thin-film battery recharging system that uses a potentiostatic charging device comprises a solar cell in accordance with the present invention;

FIG. 7 is a schematic view of another solid state thin-film battery recharging system that uses a potentiostatic charging device comprises a piezoelectric device in accordance with the present invention;

FIG. 8 is a schematic view of another solid state thin-film battery recharging system that uses a potentiostatic charging device comprises a thermoelectric device in accordance with the present invention; and

FIG. 9 is a schematic view of an exemplary tire pressure monitoring system in accordance with the present invention.

### DETAILED DESCRIPTION

In the following detailed description of the preferred embodiments, reference is made to the accompanying drawings that form a part hereof, and in which are shown, by way of illustration, specific embodiments in which the invention may be practiced. It is to be understood that other embodiments may be utilized and structural changes may be made without departing from the scope of the present invention.

It is to be understood that in different embodiments of the invention, each battery in the Figures or the description can be implemented using one or more cells, and if a plurality of cells is implemented, the cells can be wired in parallel or in series. Thus, where a battery or more than one cell is shown or described, other embodiments use a single cell, and where a single cell is shown or described, other embodiments use a battery or more than one cell. Further, the references to relative terms such as top, bottom, upper, lower, etc. refer to an example orientation such as used in the Figures, and not necessarily an orientation used during fabrication or use.

The terms wafer and substrate as used herein include any structure having an exposed surface onto which a film or layer is deposited, for example, to form an integrated circuit (IC) structure or an energy-storage device. The term substrate is understood to include semiconductor wafers, plastic film, metal foil, and other structures on which an energy-storage device may be fabricated according to the teachings of the present disclosure. The term substrate is also used to refer to structures during processing that include other layers that have been fabricated thereupon. Both wafer and substrate include doped and undoped semiconductors, epitaxial semiconductor layers supported by a base semiconductor or insulator, as well as other semiconductor structures well known to one skilled in the art. Substrate is also used herein as describing any starting material that is useable with the fabrication method as described herein

The term battery used herein refers to one example of an energy-storage device. A battery may be formed of a single cell or a plurality of cells connected in series or in parallel. A cell is a galvanic unit that converts chemical energy, e.g., ionic energy, to electrical energy. The cell typically includes two electrodes of dissimilar material isolated from each other by an electrolyte through which ions can move. Preferably, the battery includes a cathode current collector, a cathode layer, an anode layer, an anode current collector and at least one electrolyte layer located between and electrically isolating the anode layer from the cathode layer. In an embodiment of the present invention, the anode includes a lithium-intercalation material. In an embodiment of the present invention, the anode includes a lithium metal or lithium alloy material. In a preferred embodiment, the solid-state electrolyte layer includes a LiPON material. As used herein, LiPON refers generally to lithium phosphorus oxynitride materials. One example is Li₃PO₄N. Other examples incorporate higher ratios of nitrogen in order to increase lithium ion mobility across the electrolyte. In a preferred embodiment, the battery is provided in an uncharged state comprising a cathode current collector, a cathode layer that also is a source of lithium ions (such as LiCoO₂), at least one electrolyte layer comprising LiPON, and an anode current collector. Upon charging of this battery embodiment, metallic lithium is plated between the electrolyte and the anode current collector to form an anode.

The terms potentiostatic, potentiostatic charging device, and potentiostatic charging regimen refer to application of a constant charging voltage to a cell without externally limiting the current flow or the charge time other than providing a clamp of a maximum voltage in order to prevent over de-lithiation of the cathode. If the cathode is over de-lithiated, the battery exhibits a diminished charge/discharge cycle life. Of course, a minimum amount of voltage eventually must be applied at some time to the battery in order to achieve charging. It has surprisingly been found that the solid state battery charging process is note adversely affected by changes in current, intermittent sources of input power and/or input of energy even after the battery is fully charge, provided that voltage is controlled to meet the requirements of the battery as dictated by the material selection thereof. In view of this finding, it has been discovered that there is no need to utilize external current limiting circuitry or charge time circuitry in the charging process (other than the above mentioned maximum voltage clamp), thereby providing an inexpensive and elegantly simple power source system that is beneficial for numerous applications. Charge termination timers, constant current sources, and safety circuits are not necessary, thus leading to simpler, smaller, and more cost effective energy harvesting circuits.

In an embodiment of the present invention, pulse charging has been found to be a viable means of charging the thin film batteries, whereby DC pulses may be applied to the battery terminals whenever energy is available from the environment to be converted to electrical energy for the charging circuit. Thus, the use of a potentiostatic charging regimen permits charging of a thin film solid state battery with either constant or sporadic sources of input energy, as for example in the case of energy harvesting transducers that might not always have a source of mechanical, light, thermal, or other, energy to convert to electrical energy.

It has been determined that a characteristic charge potential can be determined that is specific to the materials selected for use in construction of thin film batteries that is substantially independent of the thicknesses of the components of the thin film batteries. Thus, in the embodiment where a thin film battery comprises a cathode layer that is LiCoO₂, the electrolyte layer comprises LiPON, and the anode is metallic lithium, the potential should be clamped to 4.1 (+/−0.3) volts. Similarly, in the embodiment where a thin film battery comprises a cathode layer that is LiCoO₂, the electrolyte layer comprises LiPON, and the anode is a lithium intercalation material or material suitable for forming an alloy with lithium, the characteristic potential is generally shifted from about 0.1 to 1.5 volts from the characteristic potential of the above metallic lithium anode system. The characteristic charge potential that is specific to the materials selected for use in construction of thin film batteries can be determined by cyclic voltammetry, as will be now appreciated by the skilled artisan.

Thus, in an aspect of the present invention, a battery charging system includes the feature of providing a solid state thin-film battery and a potentiostatic charging device comprising a voltage regulator and capable of maintaining a first electrode of the solid state thin-film battery at a controlled potential with respect to a second electrode of the solid state thin-film battery during a charging period, wherein the potential is controlled to a characteristic charge potential, including a suitable margin of error, that is specific to the materials selected for use in construction of the solid state thin film battery.

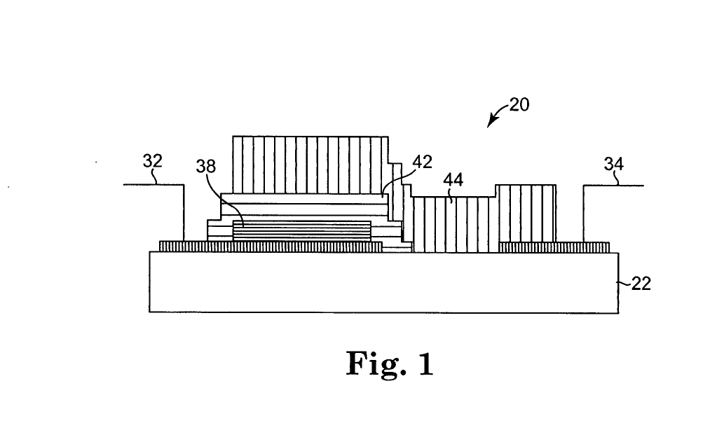

FIG. 1 shows an exemplary solid state thin-film battery 20 formed on substrate 22 and that can be used in a charging system in accordance with the present invention. The battery 20 includes a cathode current collector 32 and an anode current collector 34 formed on the substrate 22. A cathode layer 38 is formed on the cathode current collector 32. An electrolyte layer 42 is formed on the cathode layer 38. An anode layer 44 is formed on the electrolyte layer 42, the substrate 22 and the anode current collector 34. The current collectors 32 and 34 are connected to external circuitry to provide electrical power to the same. In a discharge operation, ions in the anode layer 44 travel through the electrolyte layer 42 and are stored in the cathode layer 38 thereby creating current flowing from the anode current collector 34 to the cathode current collector 32. In a charge operation, an external electrical charge is applied to the current collectors 32 and 34. Ions in the cathode layer 38 are accordingly forced through the electrolyte layer 42 and are stored in the anode layer 44.

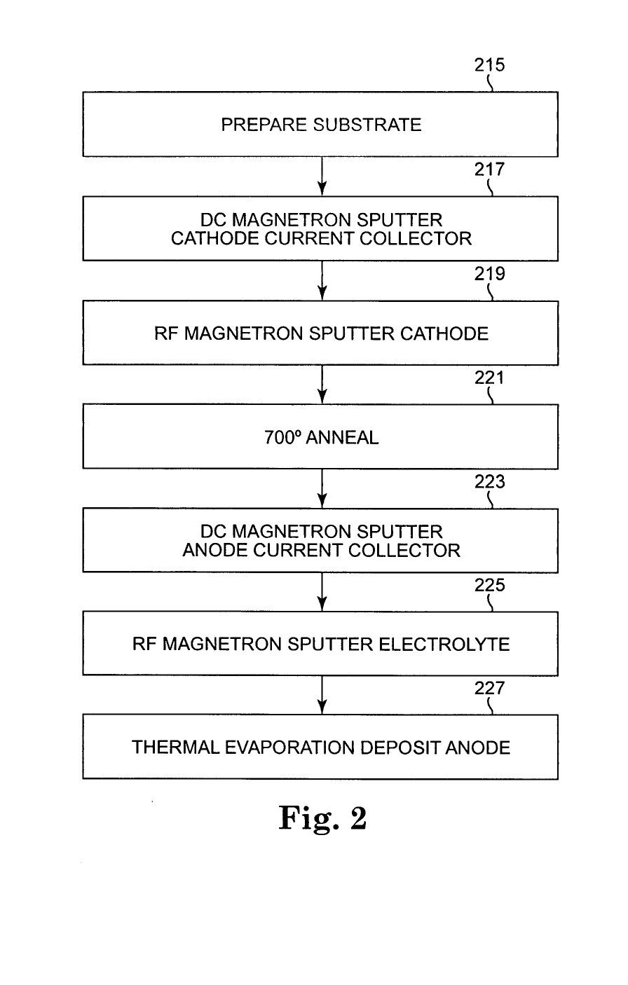

FIG. 2 shows an exemplary method for fabricating the solid state thin-film battery 20. First, the substrate 22 is prepared for deposition of the solid state thin-film battery (step 215). The cathode current collector 32 is preferably deposited on the substrate 22 using DC-magnetron sputtering (step 217) The cathode layer 38 is deposited on the cathode current collector 32 by RF-magnetron sputtering (step 219). In this method, the magnetron source provides sputtered material having energy of about 1 to 3 eV, which is typically insufficient to crystallize the cathode material to form desirable crystal structures that encourage ion movement into and out of the cathode material. The cathode is preferably annealed to produce a crystalline lattice structure in the cathode, which produces an energy-storage device that has the desired electrical performance characteristics. An exemplary electrical characteristic of a battery is a discharge curve that has a relatively constant voltage (small delta) over a range of capacity and then the voltage decreases rapidly as remaining capacity is exhausted (large delta). Accordingly, the stack of the substrate, cathode current collector and the cathode are preferably annealed at a temperature of 700 degrees Celsius (step 221 of FIG. 2A). The anode current collector is preferably deposited on the substrate by DC-magnetron sputtering (step 223). The electrolyte layer is preferably deposited by RF-magnetron sputtering (step 225). The anode is preferably deposited by thermal evaporation (step 227).

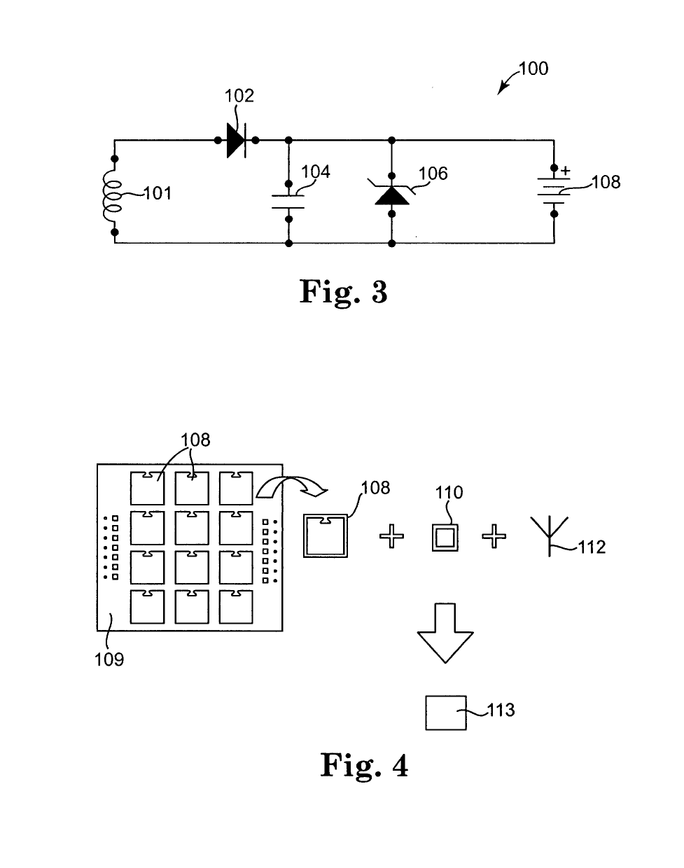

An exemplary battery charging system 100 in accordance with the present invention is schematically shown in FIG. 3. In this embodiment, the solid state thin-film battery 108 is recharged by receiving energy through a secondary coil 101 coupled magnetically to a primary coil, via electrical contacts and shunted by a voltage regulator 106 (a zener diode, for example) to clamp the voltage at a level consistent with the charging voltage of the battery 108. A filtering device, such as capacitor 104 is preferably used, as illustrated. In another embodiment, a pulsed DC current may be applied directly to the regulator. A low leakage diode 102 placed between voltage regulator 106 and battery 108 is preferably used to prevent the battery from discharging through voltage regulator 106 when insufficient energy is available to charge the battery 108.

In accordance with the present invention, charging system 100 can be used in an RFID application to provide an RFID tag 113 as shown in FIG. 4. The thin film batteries can be made on large format substrates 109, from which a battery 108 can then be separated and adhered to a surface of, for example, an RFID inlay, smart label, or smart credit card. A battery can also be laminated into cards and labels, as the solid state construction allows the cells to tolerate the heat and pressure of lamination. The battery 108 is preferably combined with an integrated circuit 110 and an antenna 112 to form RFID tag 113. In accordance with the present invention the inductive coil preferably functions as the antenna and is connected to the transponder for receiving the RF energy from the RFID tag reader. A thin film battery can also be integrated within a PVC or other laminate sheet and combined with a pick-up coil, a rectifier, and if necessary, a capacitor for filtering the pulsed DC; a series or shunt regulator provides the proper DC voltage to the battery. Thus, the battery can be charged without having to make electrical contact with it.

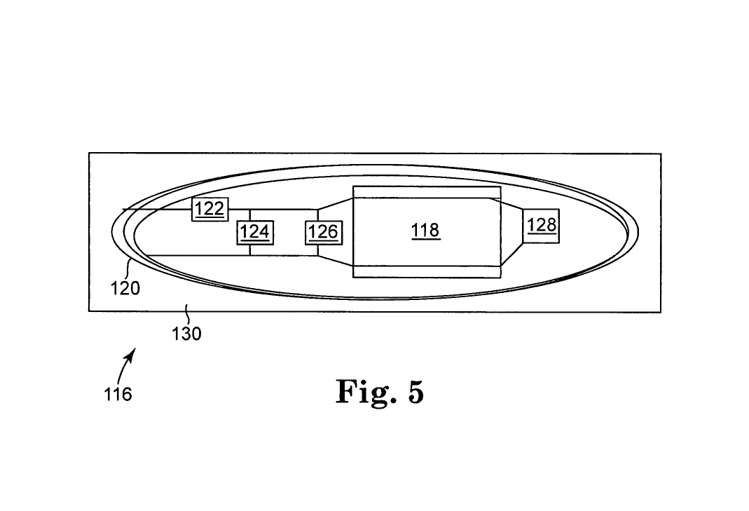

In FIG. 5 another battery charging system 116 in accordance with the present invention is schematically illustrated. Charging system 116 functions by inductively charging thin film battery 118 preferably housed in a laminated card. The system comprises a wound coil (secondary winding) 120, a rectifying circuit 122 comprising one or more diodes for converting an incoming AC signal to DC, a filter capacitor 124 for averaging the voltage, a voltage regulator 126 such as a zener diode for providing the correct charging voltage to the battery 118, an integrated circuit 128 such as an RFID transponder, interconnecting wires or circuit board traces for making electrical connections between the various components, and an enclosure 130 preferably comprising flexible or rigid material for binding all of the components to a common substrate. The primary winding can be shaped in a variety of ways, such as in the format of a flat pad, cylindrical tube, or conical in design, thus permitting the secondary winding to be brought in proximity to the primary winding and therefore deriving power from the primary winding through magnetic coupling and delivering the power to the battery via the rectifying, filtering, and regulating circuitry. In some cases, the filtering circuitry (i.e., capacitor) may not be necessary, but rather pulsed DC current may be applied directly to the regulator. Large numbers of cards could be placed in a bin or hopper with an inductive loop beneath it, permitting all of the encased batteries to be charged simultaneously.

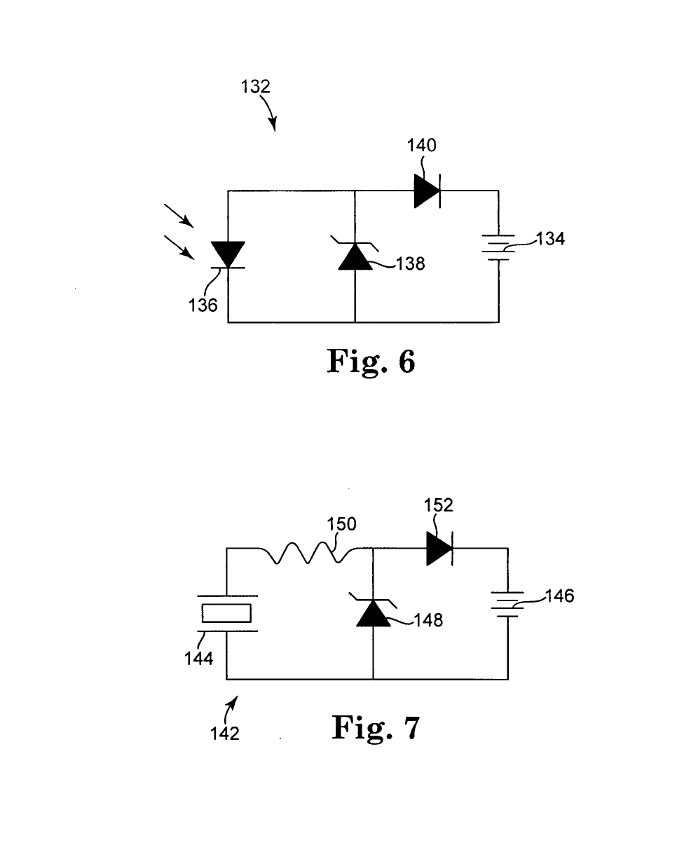

In another recharging system 132 in accordance with the present invention schematically shown in FIG. 6, battery 134 is recharged by receiving energy from the output of a solar cell 136 that converts electromagnetic radiation of a particular wavelength to energy in the form of voltage and current. This energy is then transferred to the battery 134 through electrical contacts and a voltage reference device 138 which preferably comprises a reference diode or shunt regulator with a voltage drop ranging from about 4.1V to about 4.3V nominally. A low reverse leakage rectifying diode 140 is also preferably used to prevent the battery 134 from discharging through the solar cell 136 when the solar cell 136 is in the dark.

Solar cells can be connected in series to achieve sufficient voltage to bias the regulator. Alternatively, a boost converter may be used to step up the voltage to an amplitude sufficient to charge the battery. Physically, the battery can be laminated or adhered to the inactive surface of the solar cell, which in some cases may be fabricated on a flexible foil substrate. A battery can be fabricated on one surface of the substrate, and the solar cell on the opposite surface. A substrate can comprise silicon, metal, ceramic, glass, or other materials that have the physical and thermal characteristics necessary for depositing the various materials used in the fabrication of solid state thin-film batteries and solar cells. A battery can also be fabricated on a silicon, ceramic, or glass substrate and stacked with the solar cell manufactured for example from single crystal silicon in a common package. This creates a multi-chip module that serves as an energy harvesting and energy storage unit source that can operate without need of hardwired recharging sources. Such a device would also preferably include charge control circuitry that limits the charging voltage at the battery terminals to a level that is sufficient to deliver charge to the battery without applying excessive voltage, which could possibly damage or destroy the cell. This circuit also provides a very low reverse leakage current path between the battery and the solar cell to prevent the battery from becoming discharged through the solar cell when the solar cell does not have adequate photon energy to develop adequate voltage at its output terminals. Connections between the battery, solar cell, and charge control components can be made through conventional wire bond techniques, conductive epoxies, or by soldering each device to conductive traces on a circuit board or laminate substrate, such as FR-4 or BT material. The entire module can be encapsulated if necessary in a standard epoxy, with the preference that a sufficient portion of the active surface of the solar cell be open to photon absorption. The module can contain a sensor for measuring proximity, temperature, pressure, vibration, or any other environmental parameter. This sensor is preferably powered by the solar cell and battery combination. The module can also contain a wireless transmitter for conveying the sensed information to a remote receiver. This transmitter is also preferably powered by the solar cell and/or battery. The solar cell and battery can also be fabricated on a monolithic slice of silicon, whereby the battery is fabricated alongside the solar cell, either before or after the fabrication of the solar cell. The charge control devices, including the regulator and blocking diode, can also be fabricated on the same silicon substrate.

Another charging system 142 is schematically shown in FIG. 7 and involves the transference of energy from a piezoelectric device 144 comprising a material such as a ceramic or PVDF film, to a battery 146 by electrical contacts. The charging system 142 comprises a voltage regulating or clamping device 148 to limit the magnitude of the voltage applied to the battery 146 and preferably comprises a reference diode with a voltage drop ranging from about 4.1V to about 4.3V nominally. Resistor 150 is preferably used to present a high impedance load to the piezoelectric device 144. Diode 152 prevents battery 146 from discharging through the charging circuit. Another embodiment of this charging scheme provides full-wave rectification so that both the negative and positive voltages produced by the piezoelectric device 144 are transferred to the battery 146, thus improving the energy transfer efficiency by a factor of two.

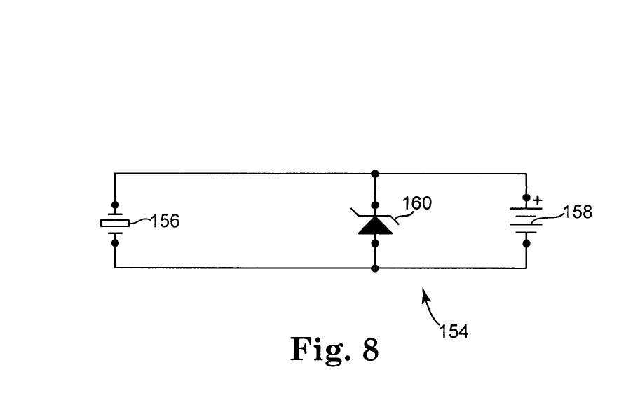

Another charging system 154 is schematically shown in FIG. 8 and involves the transference of energy from a thermoelectric device 156 to a battery 158 by electrical contacts. The charging system 154 comprises a voltage regulating or clamping device 160 to limit the magnitude of the voltage applied to the battery 158 and preferably comprises a reference diode with a voltage drop ranging from about 4.1V to about 4.3V nominally.

All of the components in the diagrams can be purchased in small, inexpensive, leaded or leadless surface mount formats, thus allowing these circuits to be embedded in a single package such as a leadless chip carrier (LCC), multi-chip module (MCM), ball grid array (BGA), micro-BGA (uBGA), system in package (SiP), and other package types, either with or without the inclusion of the thin film battery for which the control circuit is designed to charge.

In some embodiments, the present invention provides an apparatus that includes a device in a unitary package, the device including a charging input terminal; a power output terminal; a ground terminal; a thin-film lithium-ion battery having a first electrical contact electrically connected to the ground terminal and having a second electrical contact; at least two series-connected transistors that provide a selectively enabled electrical connection between the charging input terminal and the second electrical contact of the battery; at least two series-connected transistors that provide a selectively enabled electrical connection between the second electrical contact of the battery and the power output terminal; and at least two series-connected transistors that provide a selectively enabled electrical connection between the charging input terminal and the power output terminal.

Some embodiments further include a third transistor series connected with the at least two series-connected transistors that provide the selectively enabled electrical connection between the charging input terminal and the second electrical contact of the battery, wherein the third transistor is selectively enabled based on an externally applied control voltage.

In some embodiments, all of the mentioned transistors are part of a single application-specific integrated circuit (ASIC).

In some embodiments, at least some of the mentioned transistors are discrete parts.

In some embodiments, the present invention provides an apparatus that includes a device in a unitary package, the device including a charging input terminal; a power output terminal; a ground terminal; a thin-film lithium-ion battery having a first electrical contact electrically connected to the ground terminal and having a second electrical contact; at least two series-connected transistors that provide a selectively enabled electrical connection between the charging input terminal and the second electrical contact of the battery; a low-forward-voltage-drop (or Schottky) diode that provides a selectively enabled electrical connection between the second electrical contact of the battery and the power output terminal; and a low-forward-voltage-drop (or Schottky) diode that provides a selectively enabled electrical connection between the charging input terminal and the power output terminal.

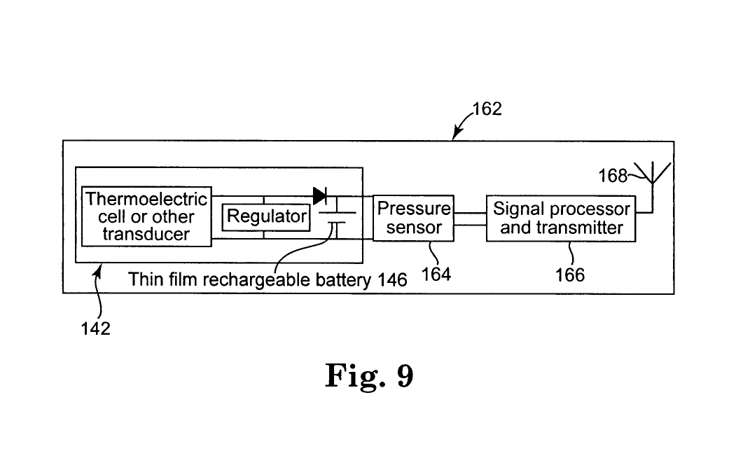

An exemplary application for charging circuits in accordance with the present invention comprises a tire pressure monitoring system 162 and is illustrated schematically in FIG. 9. As illustrated, tire pressure monitoring system 162 includes the thermoelectric based charging system 142 illustrated in FIG. 8 but any of the charging system of the present invention can be used. Battery 146 permits constant or frequent charging to replenish charge in the battery between periods of use. Because the battery is completely solid state and has a relatively large surface to thickness ratio, it can accept charge quickly and repeatedly without substantial degradation in performance or capacity.

Monitoring system 162 includes a tire pressure sensor 164 preferably comprising real-time sensing and data transmission capability, for the monitoring and reporting of tire condition on motor vehicles or the like. The pressure sensor 164 coupled to a signal processor and transmitter 166 capable of sending information via antenna 168 to an indicator for monitoring. Power is provided by rechargeable battery 146.

Because the collection of pressure information requires only a few nanoamp-hours of energy per event, the battery itself can be made quite small if recharging between events is made possible. One method for making this possible is through the use of piezoelectric materials to add charge to the battery as the tire rotates, then sizing the battery up to account for periods when the vehicle is not in motion yet in use, and further to account for self-discharge of the battery when the vehicle is parked, and further still to accommodate changes in battery capacity under a variety of operating temperatures. Solid state thin-film batteries available from Cymbet Corporation are robust enough to tolerate the extreme temperatures found within a tire, made from completely solid state materials that result in low self-discharge rates and exceptional power density, can tolerate virtually constant recharging, and yet can be made small and light enough to fit within virtually any confine and in myriad shapes. Because these batteries may be manufactured on thin, flexible, lightweight substrates, the battery mass can be kept to a fraction of a gram and affixed to the tire itself and integrated directly with the piezoelectric material that is providing the charging current.

A piezoelectric film of PVDF material, measuring roughly 1 cm×4 cm, for example, can be used. In use the film is flexed from the motion of the tire and produces a variable output voltage range from a fraction of a volt to about 20 volts, for a duration of about 10 milliseconds, depending on the nature of the strain applied to the film and the load presented to the film. The voltage generated with each rotation of the tire is then preferably rectified, either half-wave or full-wave, and preferably clamped at 4.2V so as not to exceed the charging voltage of the thin film battery. Current limiting is typically not necessary due to the nature of this battery chemistry. Accordingly, simple and inexpensive charge control circuitry can be employed.

At an average speed of 60 km/hour, a typical tire rotates about 50,000 times per hour. Consequently, the amount of charge that can be delivered to the battery translates to about 2.5 microamp-hours per hour of driving. Given that the amount of energy needed to power the pressure sensor and transmitter is on the order of 10 mA for 10 ms per transmission, the amount of energy need is 28 na-hours per transmission. This means that, to maintain equilibrium on the battery, the sensor and transmitter could be active for 2.5 uAh/28 nAh=90 pulses per hour, or about every 40 seconds. This may be an adequate sampling period, but the rate can be improved substantially by tailoring the piezoelectric film for the application and through the use of lower power transmitters. Additionally, piezoelectric materials having high strain-to-charge efficiency are presently available.

In an embodiment of the present invention, the thin-film battery and battery-charging circuit is encapsulated to form a unitary package. In an embodiment of the present invention, the encapsulating forms a thin package having an outer surface that adheres to a substrate. In a preferred aspect of this embodiment, the outer surface is selected to be suitable for adhering to rubber.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

What is claimed is:

1. A battery charging system comprising:
a solid state thin-film battery; and
a potentiostatic charging device comprising a voltage regulator and capable of maintaining a first electrode of the solid state thin-film battery at a controlled potential with respect to a second electrode of the solid state thin-film battery during a charging period.

2. The charging system of claim 1, wherein the solid state thin-film battery comprises LiPON.

3. The charging system of claim 1, wherein the potentiostatic charging device comprises a primary coil magnetically coupled to a secondary coil.

4. The charging system of claim 3, further comprising a filtering circuit.

5. The charging system of claim 1, wherein the potentiostatic charging device comprises a solar cell.

6. The charging system of claim 1, wherein the potentiostatic charging device comprises a piezoelectric transducer.

7. The charging system of claim 6 in combination with a sensor.

8. The combination of claim 7, wherein the sensor comprises an air pressure sensor.

9. The combination of claim 8 further comprising a tire.

10. The charging system of claim 6, wherein the potentiostatic charging device comprises a full wave rectification circuit capable of using both positive and negative voltages provided by the piezoelectric transducer to charge the solid state thin-film battery.

11. The charging system of claim 1, wherein the potentiostatic charging device comprises a thermoelectric cell.

12. A method of charging a solid state thin-film battery, the method comprising the steps:
providing a battery charging system comprising a solid state thin-film battery and a potentiostatic charging device comprising a voltage regulator;
providing an energy source; and
using energy from the energy source to maintain a first electrode of the solid state thin-film battery at a controlled potential with respect to a second electrode of the solid state thin-film battery during a charging period.

13. The method of claim 12, wherein the energy source comprises one or more of a primary coil magnetically coupled to a secondary coil, a solar cell, a piezoelectric transducer, and a thermoelectric cell.

14. The method of claim 12, wherein the solid state thin-film battery comprises LiPON.

15. A tire pressure monitoring system, the system comprising:
a tire pressure sensor;
a signal transmitter capable of transmitting a signal from the tire pressure sensor to a receiver; and
a power source comprising a solid state thin-film battery and a potentiostatic charging device comprising a piezoelectric transducer.

16. The tire pressure monitoring system of claim 15, wherein the solid state thin-film battery comprises LiPON.

17. The tire pressure monitoring system of claim 15, wherein the potentiostatic charging device comprises a full wave rectification circuit capable of using both positive and negative voltages provided by the piezoelectric transducer to charge the solid state thin-film battery.

18. A method of monitoring tire pressure, the method comprising the steps of:
measuring the pressure of a tire with a pressure sensor;
powering the pressure sensor with a solid state thin-film battery; and
charging the solid state thin-film battery with energy provided by a piezoelectric transducer.

19. The method of claim 18, further comprising using both positive and negative voltages provided by the piezoelectric transducer to charge the solid state thin-film battery.

20. The method of claim 18, further comprising the step of transmitting a signal indicative of tire pressure to a receiver.
